(19) United States
(12) Patent Application Publication
(10) Pub. No.: US 2012/0074712 A1
(43) Pub. Date: Mar. 29, 2012

(54) MULTI-ROTOR FLUID TURBINE DRIVE WITH SPEED CONVERTER

(75) Inventor: Faruk Bursal, Lexington, MA (US)

(73) Assignee: SYNKINETICS,INC., Framingham, MA (US)

(21) Appl. No.: 13/375,374

(22) PCT Filed: May 28, 2010
(86) PCT No.: PCT/US10/36552

§ 371 Date: Dec. 1, 2011

Related U.S. Application Data
(60) Provisional application No. 61/182,819, filed on Jun. 1, 2009.

(51) Int. Cl. F03D 9/00; F03B 13/00

(52) U.S. Cl. 290/55; 290/54

(57) ABSTRACT

Compact and highly efficient multi-rotor fluid turbine drive with speed converter for provision of a coaxial arrangement of multiple rotors driving one or more input shafts of the turbine. The relative speed of the various rotors can be predetermined and regulated during operation. Synkdrives are used with the blades to allow the blades to rotate at different speeds.

### BACKGROUND

Fluid energy has historically been used to perform useful work ranging from milling grain to land reclamation. More recently, the potential of using moving fluids to produce electric power has begun to be exploited.

Wind or hydrokinetic (water power without dams) turbines both require a device called a generator in order to transform the mechanical power of their rotating blades into electric power.

When the speed of the blades is allowed to change with the fluid speed, more optimal operation of the turbine over a range of fluid speeds is enabled. For example, a widely used measure of how closely a wind turbine can keep up with changing wind conditions is the “tip speed,” which is a non-dimensional ratio of the linear speed of the blade at its tip to the wind speed. The “design tip speed” of the wind turbine denotes the value of the tip speed, for which the energy extraction efficiency of the blades from the wind is maximized. An ideal set of blades will have a relatively small inertia, so that its turning speed can quickly keep up with changes in wind speed and keep its tip speed as close as possible to the design tip speed.

The theoretical maximum power extraction coefficient for wind turbines was first presented by A. Betz in “Wind-Energie and Ihre Ausnützung durch Windmühlen,” van den Hoeck & Ruprecht, Göttingen, 1926 (in German). According to Betz, the amount of power that can be extracted by a turbine from a horizontal column of wind is proportional to the swept area of the blades, and is further limited to about 59% of the total power contained in the column of wind.

The part of a wind turbine that can yaw with respect to the tower, and which houses the generator and the blade hubs among other things, is called the nacelle. The aerodynamic action of the wind on the blades of the rotor causes lift, which in turn causes the rotor to rotate about its hub. Typical rotation speeds at the blade hub are in the 10-20 rpm range; however, such speeds are generally too low for a generator to efficiently convert the mechanical rotation into electric power, requiring a bulkier generator. Some turbines on the market today utilize direct drive generators due to the simplicity and inherent reliability of a gearless system, but the majority of turbines use speed-up gearing in order to allow the generator to perform more effectively. A further advantage of a speed-up is that the torque on the generator shaft is smaller than that on the blade hub, making it easier to brake the rotor in case of dangerously high winds. The main disadvantages of multi-stage gearing are mechanical losses, complexity, and issues with reliability. Wind loads on the rotor can be highly uneven, with sudden wind gusts causing near shock loading on gear teeth and potentially leading to broken teeth. With so many wind turbines being located in out of the way places, servicing a turbine becomes a significant complication, even ignoring the losses associated with the turbine not producing any power when it is out of commission. Therefore, achieving speed conversion without gears is highly desirable. Despite all the design improvements to date, practical power extraction coefficients for wind

turbines still fall well short of Betz' theoretical maximum of 59%, instead hovering around 40%. This means that nearly ⅓ of the extractable power escapes unused. There are many reasons for this. For one, any set of blades does not fully stop the wind that hits it, instead imparting rotation and a net radially outward motion to it. Furthermore, no matter how optimal the shape of the blade, the linear blade velocity increases from the hub to the tips, such that not every point on the blade can be at an optimal speed relative to the wind at the same time. One possibility that has been proposed to remedy this situation is to use a multi-rotor system. In principle, a second rotor that is placed leeward of the first rotor will extract some more power from the column of wind that has escaped the first rotor, thereby adding to the overall power conversion efficiency of the turbine. It has been estimated that up to 40% of the escaped energy might by captured by such means.

Due to the rotation that is imparted to the column of fluid by the first rotor, the second rotor should have differently angled blades as compared to the first rotor. In this regard, a second rotor that is counter-rotating relative to the first rotor is more advantageous than a second rotor that is co-rotating with (i.e., rotating in the same direction as) the first rotor. Nonetheless, some inventors have demonstrated that a multiplicity of rotors all rotating in the same direction can also be superior to a single rotor. The main advantage of rotors mounted on the same shaft and rotating at the same speed are simplicity and the fact that the blades cannot run into each other as they rotate. However, there also are a number of reasons that favor unequal rotation speeds. For one, similar rotors all rotating at the same speed can lead to sympathetic vibrations and cause premature fatigue failures. In addition, the fact that the fluid has already gone through one rotor will have slowed it down, such that leeward rotors will need to rotate at a slower speed in order to operate near their optimum in terms of extracting power from the fluid. Indeed, generally, having means to adapt the blade speed to the fluid speed in order to extract maximum power is considered desirable.

A further advantage of a counter-rotating arrangement over a co-rotating arrangement is that the net moment load on the support structure is lessened. Each rotor receives a torque input from the fluid stream, which is eventually passed to the support structure. If there is a counter-rotating rotor, then its torque input from the fluid stream tends to cancel out that from the first rotor, allowing a more optimized, less costly design for the structure.

Providing a system that enables the effective rotation of a least two rotors or blades on a wind turbine, hydrokinetic turbine or the like is difficult to obtain. In particular many problems arise in the effective provision of counter-rotating blades on a wind turbine, hydrokinetic turbine or the like.

### SUMMARY

Fluid energy systems use the energy contained in moving or accumulated fluid in order to do useful work. Most such systems use either air (wind) or water. In the case of water power, the water is either gathered behind a dam (conventional hydropower) or used in its natural moving state without a dam (hydrokinetic power). Hydrokinetic power generation is the use of the kinetic energy of natural currents in order to produce useful power. This is sometimes also referred to as instream power generation. In contrast to conventional hydropower, hydrokinetic power generation requires less infrastructure and can be installed cost-effectively even on small scales.

The main advantages of rotors mounted on the same shaft and rotating at the same speed are simplicity and the fact that the blades cannot run into each other as they rotate. However, there also are a number of reasons that favor unequal rotation speeds. For one, similar rotors all rotating at the same speed can lead to sympathetic vibrations and cause premature fatigue failures. In addition, the fact that the fluid has already gone through one rotor will have slowed it down, such that leeward rotors will need to rotate at a slower speed in order to operate near their optimum in terms of extracting power from the fluid. Indeed, generally, having means to adapt the blade speed to the fluid speed in order to extract maximum power is considered desirable.

The same arguments apply to wind turbines apply to hydrokinetic or non-dam water turbines. Typical installations of such turbines are near river bends or tidal channels where the water velocity is maximized. It is imperative to keep turbines from impeding (or being damaged by) watercraft. However, servicing concerns favor turbines being mounted in close proximity to existing infrastructure. The combination of these aims limits potential sites for hydrokinetic power, making it that much more desirable to extract more power from a turbine by using counter-rotating rotors. It is also true that counter-rotation reduces turbulence downstream from the turbine and adds to its dynamic stability.

Due to the rotation that is imparted to the column of fluid by the first rotor, the second rotor should have differently angled blades as compared to the first rotor. In this regard, a second rotor that is counter-rotating relative to the first rotor is more advantageous than a second rotor that is co-rotating with (i. e. , rotating in the same direction as) the first rotor. Nonetheless, some inventors have demonstrated that a multiplicity of rotors all rotating in the same direction can also be superior to a single rotor. The main advantages of rotors mounted on the same shaft and rotating at the same speed are simplicity and the fact that the blades cannot run into each other as they rotate. However, there also are a number of reasons that favor unequal rotation speeds. For one, similar rotors all rotating at the same speed can lead to sympathetic vibrations and cause premature fatigue failures. In addition, the fact that the fluid has already gone through one rotor will have slowed it down, such that leeward rotors will need to rotate at a slower speed in order to operate near their optimum in terms of extracting power from the fluid. Indeed, generally, having means to adapt the blade speed to the fluid speed in order to extract maximum power is considered desirable.

A further advantage of a counter-rotating arrangement over a co-rotating arrangement is that the net moment load on the support structure is lessened. Each rotor receives a torque input from the fluid stream, which is eventually passed to the support structure. If there is a counter-rotating rotor, then its torque input from the fluid stream tends to cancel out that from the first rotor, allowing a more optimized, less costly design for the structure. Providing a system that enables the effective rotation of a least two rotors or blades on a wind turbine, hydrokinetic turbine or the like is difficult to obtain without the system of syndrives as used in the present invention.

These and other needs are well met by the presently disclosed, compact and highly efficient multi-rotor fluid turbine drive with speed converter. The invention is directed towards the provision of a coaxial arrangement of multiple rotors driving one or more input shafts of the turbine.

More specifically, but not limited to, the present invention provides a multi-rotor fluid turbine, in which all rotors are positioned co-axially for minimum frontal area; allows all rotors to drive the same generator; allows each additional rotor to rotate at an optimal speed, independent of the speed of other rotors; allows both counter-rotating and co-rotating rotors to drive the same shaft; and provides a multi-rotor fluid turbine that minimizes reaction torques on the supporting structure of the turbine.

In one embodiment of the invention, a windward rotor or blade directly drives an input shaft, while a counter-rotating leeward rotor or blade drives the same input shaft through a speed converter. The speed ratio of this converter can be designed, so as to provide a desired relative rate of rotation between the two rotors, including but not limited to equal and opposite rotation speeds. In another embodiment, the speed converter has a primary cam for providing a rotary input in a first direction, and a secondary cam to interact therewith via rolling elements captured within slots of an intermediate carrier. For ease of presentation, these cams, cam tracks or discrete cams are generally referred to as cams. Either the primary or secondary cam has a plurality of cycles, which at times may appear to be tooth-like and may be referred to as cycles, lobes or teeth without distinction.

In another embodiment, a windward rotor directly drives a shaft, whereas a leeward rotor rotating in the same direction as the windward rotor indirectly drives the same shaft through a speed converter. The difference between this speed converter and that used in the embodiment with the counter-rotating leeward rotor is that this speed converter is direction-preserving, whereas the other speed converter is direction-reversing. Both types of converters use cams and rolling elements captured within slots of an intermediate carrier. The difference in output direction may be due to which element is assigned which function (input, output or ground), or to how many slots and corresponding rolling elements are interposed between the cams. In some embodiments of the invention, a clutch-brake is positioned between the counter-rotating rotors and allows slowing down the blades by braking them against each other. In other cases, a similar clutch-brake is used between ground and a component of the speed converter, so as to allow ground to “slip” and temporarily change the output speed of the speed converter.

Various embodiments of the invention include further speed converters between the rotors and the generator of the fluid turbine, in order to influence the relative speed of rotation of the two rotors, and/or the speed of the generator shaft itself. In one of these embodiments, the rotor and stator of the generator are driven separately and in opposite directions, resulting in an increase of the relative speed between them as compared to driving the rotor alone.

The below description of the design and operation of the speed converters can be applied to various embodiments and should be understood to do so, even though one or the other embodiment is shown or described for ease of presentation. In other words, the following description is provided by way of illustration and not limitation.

In one radial embodiment, the primary and secondary cams are each formed on the lateral face of a primary or secondary disk. Each of the primary and secondary cams has various flank portions. A respective rolling element (ball or roller) in a respective radial intermediate carrier slot is oscillated between a minimum and maximum radius by the primary cam. In one embodiment, the carrier is grounded and the secondary cam is the output element. In other embodiments, the carrier may be an input or output member, while one of the cams is grounded. In yet other embodiments, two elements may be the input and one element the output.

In various embodiments, the slot locations and the slot angles on the intermediate carrier are selected in recognition of the fact that for a rotating primary cam, e. g., clockwise, the carrier must locate the rolling elements such that the rise side of the primary cam interacts with the clockwise side of the cycles of the secondary cam (for clockwise driven rotation) or with the counterclockwise side of the cycles of the secondary cam (for counterclockwise driven rotation). Thus the configuration of the intermediate carrier is changed according to whether a reversing or non-reversing output is desired.

In one embodiment, the primary cam has a driving flank with a contour that varies substantially linearly with angular rotation at a first rate of variation. The secondary cam has a driven flank with a contour that varies substantially linearly with angular rotation at a second rate of variation. These cams are designed according to the cams described in U.S. Pat. No. 5,312,306, incorporated herein by reference in its entirety and assigned to the present assignee of this invention. Another patent of interest is U.S. Pat. No. 6,186,922, incorporated herein by reference in its entirety and assigned to the present assignee of this invention. Other waveforms, including those based on linear spiral segments and on sinusoidal curves, and others, can be used in practice of the present invention.

A device for changing fluid flow through a pair of blades from a first type of energy to a second type of energy:

a first blade connected to a single shaft to receive the fluid flow and rotate the first blade in a first direction; a second blade connected to the single shaft to receive the fluid and rotate the second blade in a second direction; and the second blade connected to the single shaft by an inner cam that is mounted to the single shaft, an outer cam, a reaction carrier that is grounded and at least one rolling element; the single shaft connected to a generator for transferring the fluid flow into electrical energy; wherein the single shaft rotates in a single direction. Or,

first blade connected to a single shaft to receive the fluid flow and rotate the first blade in a first direction; a second blade connected to the single shaft to receive the fluid and rotate the second blade in the first direction; and the second blade connected to the single shaft by an inner cam that is mounted to the single shaft, an outer cam that is grounded, a reaction carrier and at least one rolling element; the single shaft connected to a generator for transferring the fluid flow into electrical energy; wherein the single shaft rotates in a single direction. Or,

a first blade connected to a first shaft to receive the fluid flow and rotate the first blade in a first direction; the first shaft connected to a second shaft by a first inner cam that is mounted to the second shaft, a first outer cam, a first reaction carrier that is mounted to the first shaft and at least one rolling element; a second blade connected to the second shaft and to receive the fluid and rotate the second blade in a second direction; and the second blade connected to the second shaft by an inner cam that is mounted to the second shaft, an outer cam, a reaction carrier that is grounded and at least one rolling element; the second shaft connected to a generator for transferring the fluid flow into electrical energy; wherein the second shaft rotates in the same direction as the first direction. Or,

a first blade connected to a first shaft to receive the fluid flow and rotate the first blade in a first direction; the first shaft connected to a second shaft by a first inner cam that is mounted to the second shaft, a first outer cam that is mounted to the first shaft, a first reaction carrier and at least one rolling element; a second blade connected to the second shaft and to receive the fluid and rotate the second blade in the first direction; the second blade connected to the second shaft by an inner cam that is mounted to the second shaft, an outer cam that is connected to the second blade, a reaction carrier that is grounded and at least one rolling element; the second shaft connected to a generator for transferring the fluid flow into electrical energy; and wherein the second shaft rotates in the opposite direction of the first direction. Or,

first blade connected to a first shaft to receive the fluid flow and rotate the first blade in a first direction; a second shaft having an inner cam that is mounted to the second shaft, an outer cam grounded, a reaction carrier that is attached to the first shaft and at least one roller element; the second shaft having a reaction carrier, a third shaft having an inner cam that is mounted to the third shaft, the outer cam grounded, a reaction carrier that is attached to the second shaft and at least one roller element; the third shaft connected to a generator for transferring the fluid flow into electrical energy; and wherein the second shaft and the third shaft rotates in the same direction as the first direction. Or,

a first blade connected to a first shaft to receive the fluid flow and rotate the first blade in a first direction; a second blade connected to a first shaft to receive the fluid flow and rotate the second in a first direction; an intermediate element having an inner cam, a reaction carrier that is attached to the first shaft and at least one roller element, a second shaft having an inner cam that is mounted to the second shaft, an outer cam formed on the intermediate element, a reaction carrier that is grounded and at least one roller element; the second shaft is connected to a generator for transferring the fluid flow into electrical energy; and wherein the second shaft rotates in the opposite direction of the first direction. Or,

a first blade connected to a first shaft to receive the fluid flow and rotate the first blade in a first direction; the first shaft connected to a second shaft by a first inner cam that is mounted to the second shaft, a first outer cam grounded, a first reaction carrier that is mounted to the first shaft and at least one rolling element, the second shaft connected to the rotor of a generator; a second blade connected to a stator of the generator and to receive the fluid and rotate the second blade in a second direction; and the second blade connected to the stator by an inner cam that is mounted to the stator, an outer cam, a reaction carrier that is grounded and at least one rolling element; wherein the second shaft rotates opposite the stator. Or,

a first blade connected to a first shaft to receive the fluid flow and rotate the first blade in a first direction; the first shaft connected to a second shaft by a first inner cam that is mounted to the second shaft, a first outer cam, a first reaction carrier that is mounted to the first shaft and at least one rolling element; a second blade connected to the second shaft and to receive the fluid and rotate the second blade in a second direction; and the second blade connected to the second shaft by an outer cam that is mounted to the second shaft; the second shaft connected to a generator for transferring the fluid flow into electrical energy; wherein the second shaft rotates in the same direction as the first direction.

In its various embodiments, the present invention is directed to a provision of a coaxial arrangement of multiple rotors driving one or more input shafts of a fluid turbine. In some other embodiments of the invention, planetary or bevel gear configurations are taught that also offer this in-line transmission configuration.

### BRIEF DESCRIPTION OF THE DRAWINGS

These and other features and advantages of the present invention will be more fully understood by reference to the following detailed description in conjunction with the attached drawing in which like reference numerals refer to like elements and in which:

FIG. 1 is a cross sectional view of an embodiment of the present invention that has counter-rotating rotors;

FIG. 2 is an end view of a nominally direction-reversing speed converter used in embodiments of the present invention, showing unequal numbers of lobes on the inner and outer cams;

FIG. 3 is an exploded view of a speed converter of embodiments of the present invention;

FIG. 4 is an end view of a nominally direction-preserving speed converter used in embodiments of the present invention;

FIG. 5 is an end view of a nominally direction-reversing speed converter used in embodiments of the present invention, showing equal numbers of lobes on the inner and outer cams;

FIG. 6 is a cross sectional view of an embodiment of the present invention that has co-rotating rotors;

FIG. 7 is a cross sectional view of an alternative embodiment of the present invention that has counter-rotating rotors;

FIG. 8 is a cross sectional view of an alternative embodiment of the present invention that has co-rotating rotors;

FIG. 9 is a cross sectional view of multi-stage speed converter of an embodiment of the present invention wherein the stages are stacked axially;

FIG. 10 is a cross sectional view of multi-stage speed converter of an embodiment of the present invention wherein the stages are stacked radially;

FIG. 11 is a cross sectional view of an alternative embodiment of the present invention, with counter-rotating rotors separately driving the rotor and stator of the generator;

FIG. 12 is a cross sectional view of an alternative embodiment of the present invention, showing an open center and other features to aid in cooling;

FIG. 13 is a cross sectional view of an alternative embodiment of the present invention that has counter-rotating rotors separately driving two components of a speed converter;

FIG. 14 is a cross sectional view of an embodiment of the present invention that has counter-rotating rotors and a clutched ground;

FIG. 15 is a cross sectional view of an alternative embodiment of the present invention that has counter-rotating rotors and a clutched ground;

FIG. 16 is a cross sectional view of an alternative embodiment of the present invention that has counter-rotating rotors and a clutched ground;

FIG. 17 is a cross sectional view of a bevel gear embodiment of the present invention that has counter-rotating rotors;

FIG. 18 is a cross sectional view of a planetary gear embodiment of the present invention that has counter-rotating rotors;

FIG. 19 is a cross sectional view of a planetary gear embodiment of the present invention that has co-rotating rotors;

FIG. 20 is a cross sectional view of an alternative planetary gear embodiment of the present invention that has counter-rotating rotors;

FIG. 21 is a cross sectional view of an alternative planetary gear embodiment of the present invention that has counter-rotating rotors;

FIG. 22 is a cross sectional view of yet another alternative planetary gear embodiment of 30 the present invention that has counter-rotating rotors.

### DETAILED DESCRIPTION

The numerous design features of the various embodiments of this invention provide, but are not limited to, various advantages over past designs, such as, for example: minimum frontal area,

ability of all rotors to simultaneously drive the same generator, ability to choose (and, in some embodiments, actively regulate) the speed of each rotor for optimum power extraction from the fluid,

allowing both counter- and co-rotating rotors to drive the same shaft, and minimize reaction torques on the supporting structure.

For purposes of clarity in understanding the various embodiments of the invention, all components of a wind mill, wind turbine or hydrokinetic turbine? that may be conventional have been omitted, with only those components related directly to the embodiments of this invention being shown and described. For further ease of understanding of the embodiments, many like or substantially like elements may be designated with identical reference numerals. However, in certain instances these substantially like elements may be given different reference numerals to better understand the various embodiments. Also, the terms rotors and blades may be used interchangeably without affecting the basic concept of this invention. The embodiments may be depicted in the context of a wind turbine in the description by way of example and not limitation. A person skilled in the art will appreciate that the same substantial design can be applied to a hydrokinetic or other fluid turbine.

In its various embodiments the present invention provides, but is not limited to, a multi-rotor fluid turbine drive system that utilizes uniquely configured cams and rollers, and that is capable of providing a compact, in-line arrangement wherein the multiple rotors can drive one or more concentric shafts.

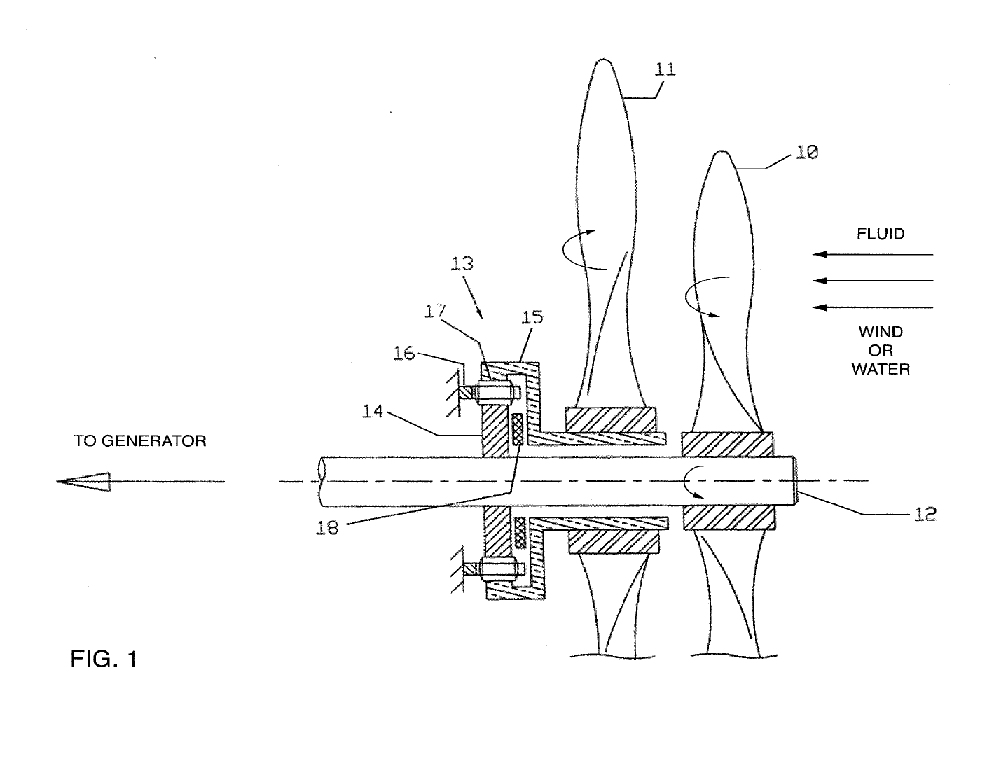

FIG. 1 shows an embodiment of the invention. Here, windward rotor 10 and leeward rotor 11 have their blades angled in opposite directions when viewed from their respective hubs, such that they counter-rotate in response to the fluid flow. As stated above, throughout the specification, the terms rotors and blades at times can be used interchangeably with numerals 10 and 11, for example, designating both rotors and blades, if desired. Rotor 10 is mounted directly on shaft 12, which leads, either directly, or through further speed conversion stages (not shown), to a generator (not shown). Rotor 11 drives the same shaft 12 through a speed converter 13. This speed converter 13 includes an inner cam 14 that is mounted on shaft 12 and constitutes the output of the speed converter. Also included in speed converter 13 are an outer cam 15 that is driven by rotor 11, and a reaction carrier 16 that is grounded. Carrier 16 has a number of slots (not shown), each housing a respective rolling element 17, shown here as a roller. The term roller may be used henceforth to refer to rolling elements in general, by way of illustration but not limitation. FIG. 1 also shows a clutch-brake 18 that is positioned between the two counter-rotating rotors 10 and 11. When this clutch-brake 18 is engaged, the two rotors are braked against each other and can therefore be slowed down and stopped with minimal reaction torque on the turbine housing.

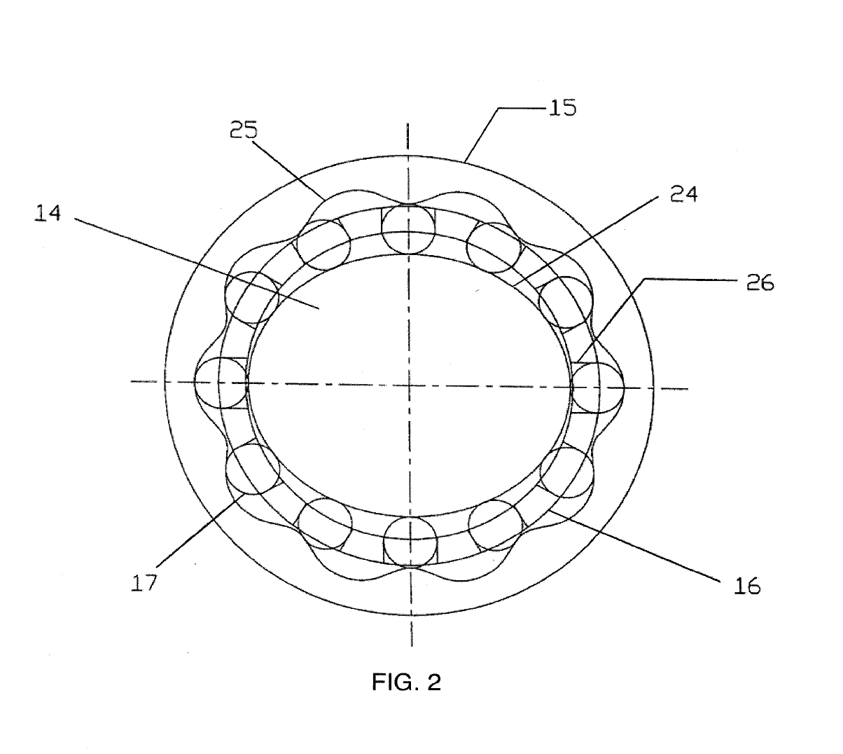

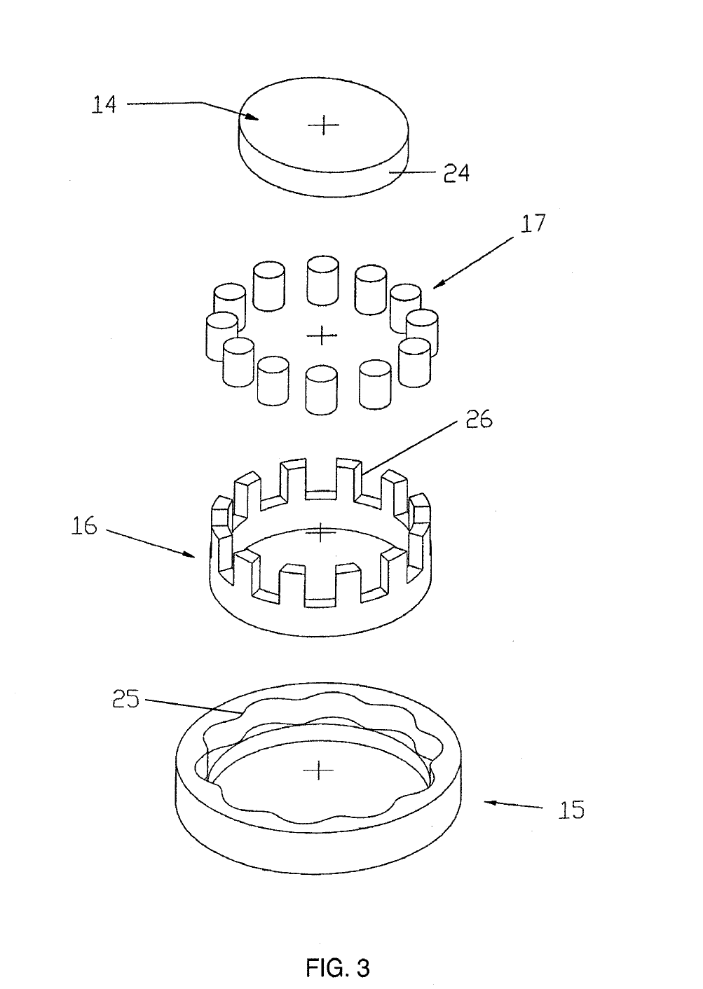

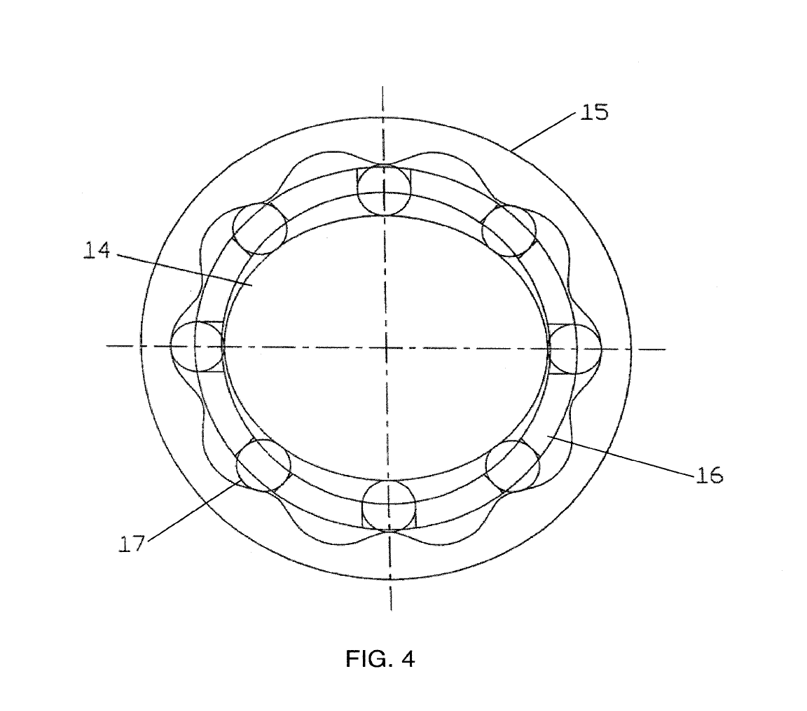

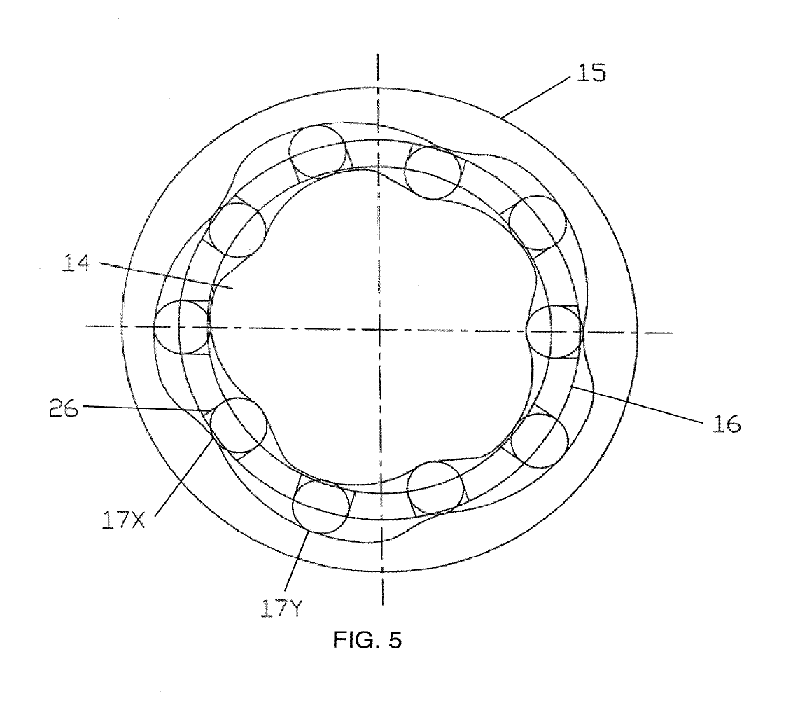

FIG. 2 shows an end view of a nominally reversing speed converter 13 of the type used in an embodiment of the present invention. Inner cam 14 has a cam flank 24, which contacts rollers 17 that can move radially within slots 26 of carrier 16. The rollers 17, in turn, are in contact with flank 25 of outer cam 15. In the embodiment shown in FIG. 1, carrier 16 is grounded, outer cam 15 is the input and inner cam 14 is the output. The speed converter as shown in FIG. 2 would behave as a direction-reversing speed increaser in that case. The nominal ratio of such a speed converter is found by dividing the number of lobes on outer cam 15 by the number of lobes on inner cam 14, and is equivalent to the ratio of ring gear teeth to sun gear teeth in a planetary gearset. If the number of slots 26 in carrier 16 equals the sum of the numbers of lobes on the two cams, the output rotates in the opposite direction from the input when the carrier is grounded. FIG. 3 shows an exploded view of the same speed converter 13. Depicted in FIG. 4 is an alternative embodiment of a speed converter of the present invention, one that is direction-preserving between input and output when carrier 16 is grounded. In this configuration, the number of slots 26 in carrier 16 equals the difference of the numbers of lobes on outer cam 15 and inner cam 14. In contrast, FIG. 5 shows a nominally direction-reversing speed converter analogous to the one shown in FIG. 2, but with the distinction that the cam lobes are asymmetrically shaped between their respective minimum and maximum radii. This enables the speed converter in FIG. 5 to achieve a direction-reversing 1:1 speed ratio between inner cam 14 and outer cam 15 when carrier 16 is grounded. If the shape of the cam lobes were symmetric, this particular ratio would not be achievable, because all rollers would be at the minimum or maximum radius positions simultaneously, rendering the driving cam unable to impart any torque to the rollers. With asymmetric cam lobes as shown, however, rollers 17Y are still able to be driven, even when rollers 17X are at minimum radius position within carrier slots 26.

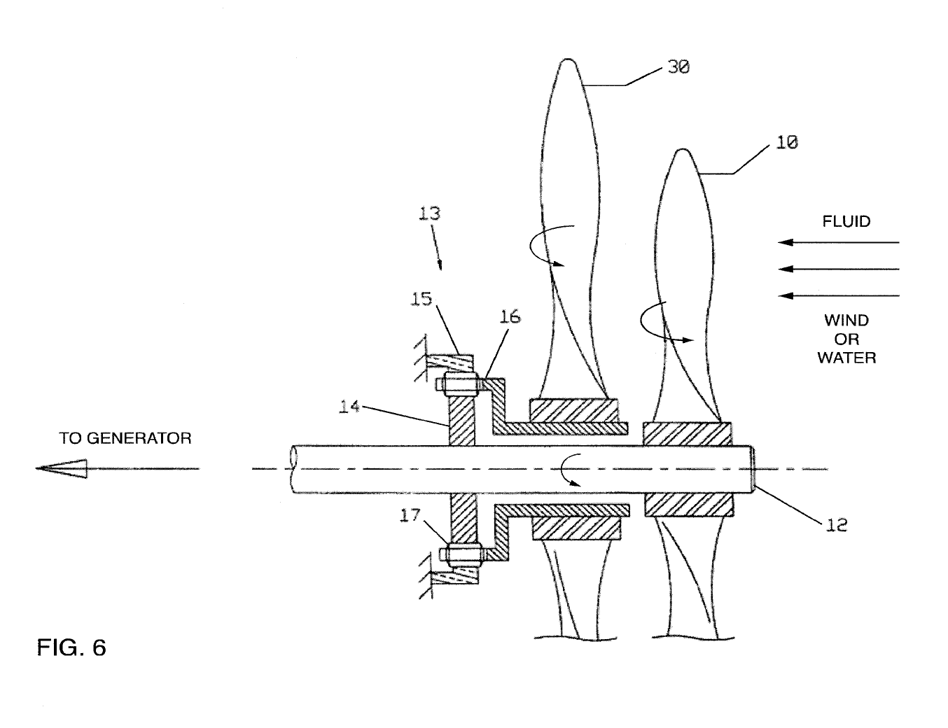

FIG. 6 shows another embodiment of the invention. Here, windward rotor 10 and leeward rotor 30 have their blades angled in the same direction when viewed from their respective hubs, such that they co-rotate (that is, rotate in the same direction) in response to the moving fluid. Rotor 10 is mounted directly on shaft 12, which leads, either directly, or through further speed conversion stages (not shown), to the generator (not shown). Rotor 30 drives the same shaft 12 through a speed converter 13. This speed converter includes an inner cam 14 that is mounted on shaft 12 and constitutes the output of the speed converter. Also included in speed converter 13 are a reaction carrier 16 that is driven by rotor 30, and an outer cam 15 that is grounded. Carrier 16 has a number of slots 26 (not shown), each housing a respective roller 17. In this case, because the nominally direction-reversing speed converter 13 has its outer cam 15 grounded, the output (inner cam 14) rotates in the same direction as the input (carrier 16).

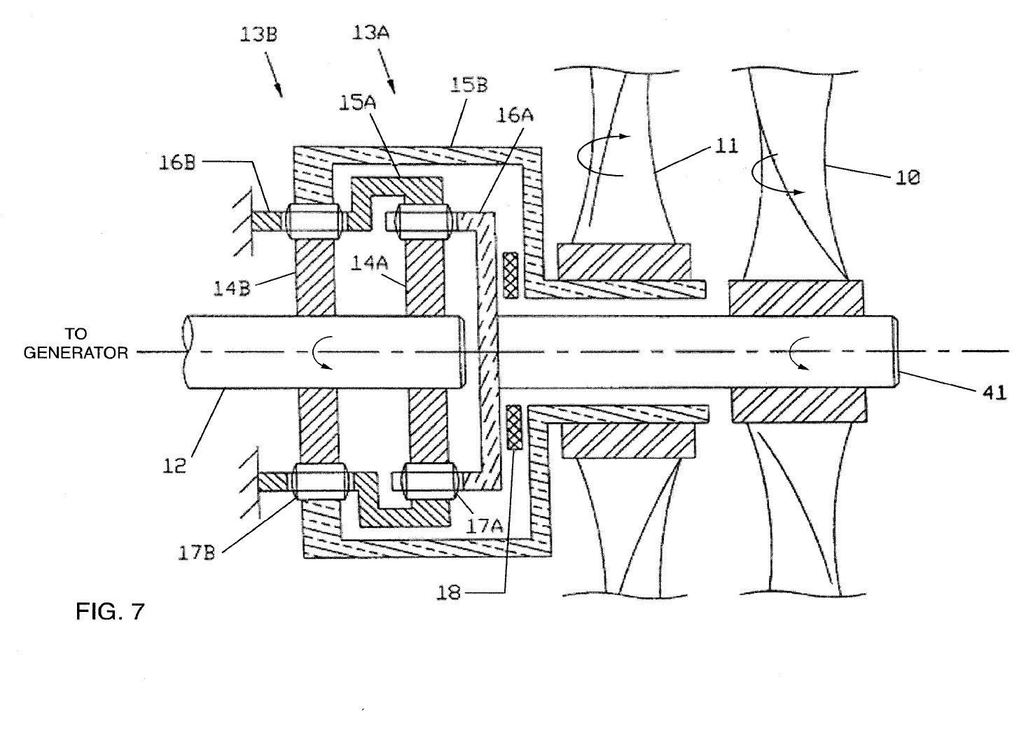

FIG. 7 shows an alternative embodiment of the invention in which windward rotor 10 and leeward rotor 11 counter-rotate in response to the moving fluid. Rotor 10 is mounted on stub shaft 41, which drives carrier 16A of a first speed converter 13A. Rotor 11 drives outer cam 15B of a second speed converter 13B. Inner cams 14A and 14B of both speed converters are mounted on shaft 12 and constitute the output of the speed converters. Also included in first speed converter 13A is an outer cam 15A that is grounded. Likewise, included in second speed converter 13B is a carrier 16B that is grounded. Because they are both grounded, outer cam 15A and carrier 16B may be formed on the same physical part in practice. Carriers 16A and 16B have a number of slots (not shown), each housing a respective roller 17A or 17B.

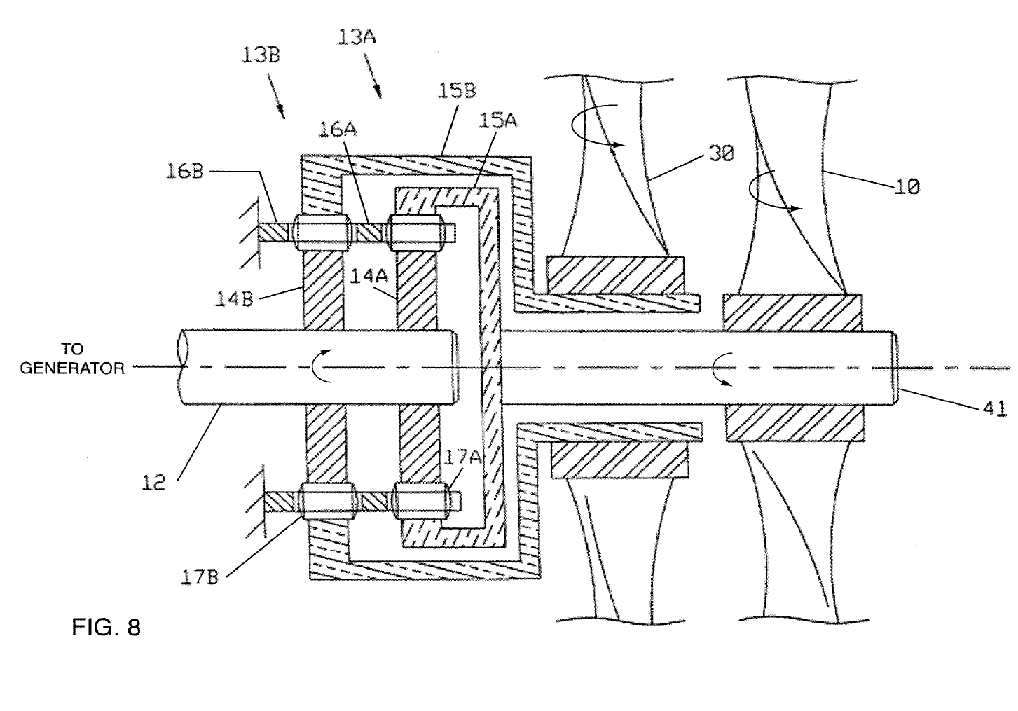

FIG. 8 shows an alternative embodiment of the invention in which windward rotor 10 and leeward rotor 30 co-rotate in response to the moving fluid. Rotor 10 is mounted on stub shaft 41, which drives outer cam 15A of a first speed converter 13A. Rotor 30 drives outer cam 16B of a second speed converter 13B. Inner cams 14A and 14B of both speed converters are mounted on shaft 12 and constitute the output of the speed converters. Also included in first speed converter 13A is carrier 16A that is grounded. Likewise, included in second speed converter 13B is a carrier 16B that is grounded. Because they are both grounded, carriers 16A and 16B may be formed on the same physical part in practice.

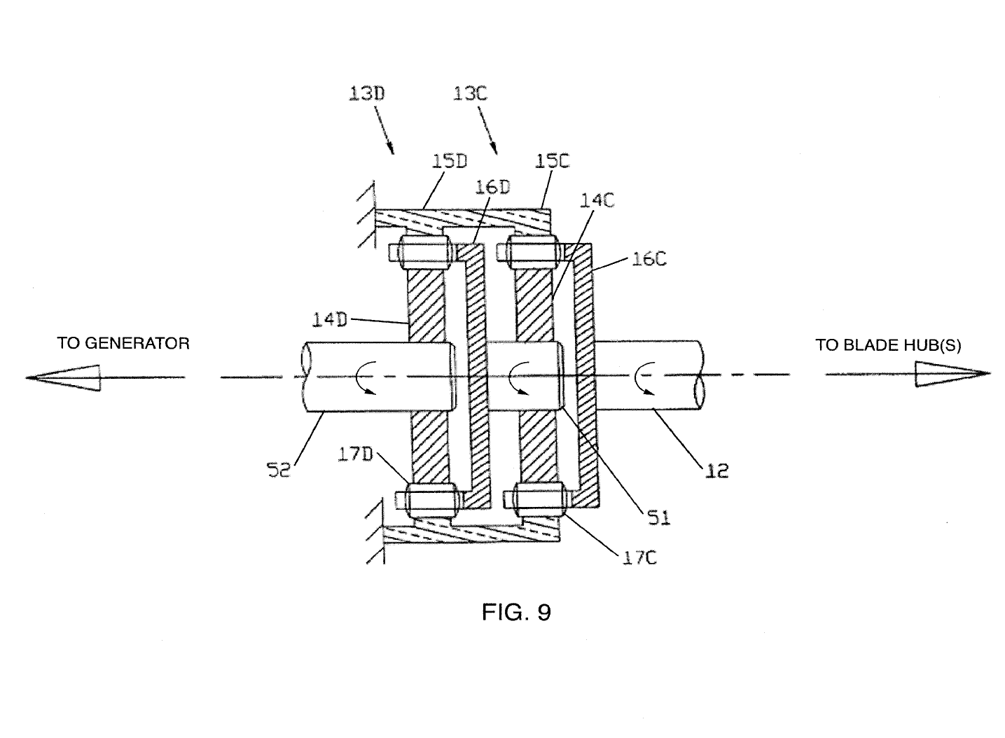

Depicted in FIG. 9 is a multi-stage speed converter that may be interposed between the blade hubs and the generator shaft 52. Two stages of speed conversion are shown, but it will be understood that more stages could be added analogously. Speed converters 13C and 13D are arranged in an axial stack. Shaft 12 drives carrier 16C of speed converter 13C, which has its outer cam 15C grounded. Output is taken through inner cam 14C, which drives carrier 16D of speed converter 13D by way of stub shaft 51. Outer cam 15D is grounded, and may in practice be formed on the same physical part as outer cam 15C. Inner cam 14D is the output of speed converter 13D, and drives shaft 52, which may lead to further stages of speed conversion, or directly to the rotor of the generator (not shown).

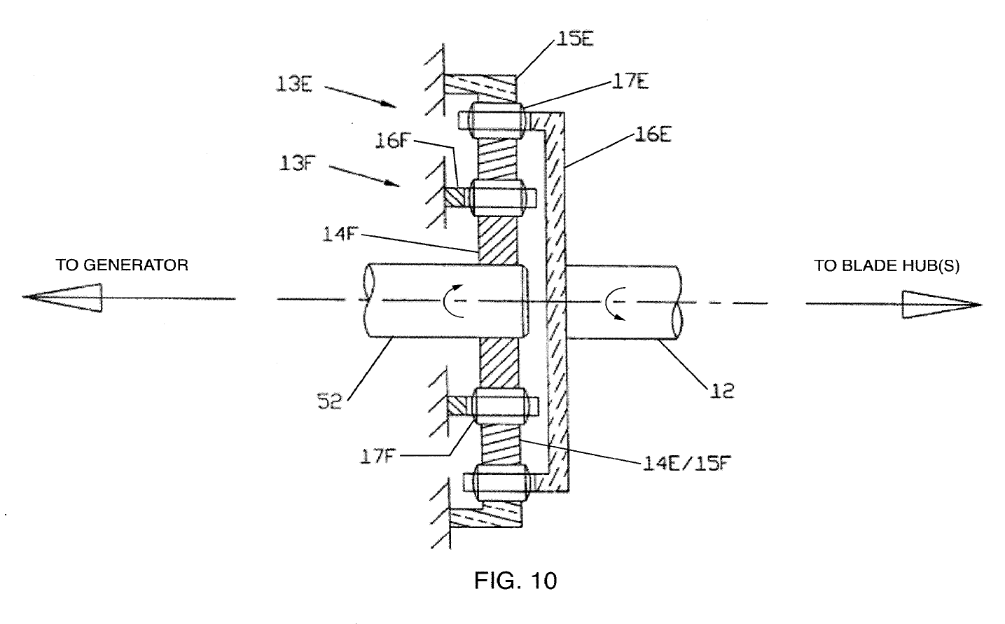

FIG. 10 shows an alternative embodiment of a multi-stage speed converter that may be interposed between the blade hubs and the generator shaft 52. Two stages of speed conversion are shown, but it will be understood that more stages could be added analogously. Speed converters 13E and 13F are arranged in a radial stack. Shaft 12 drives carrier 16E of speed converter 13E, which has its outer cam 15E grounded. Output is taken through inner cam 14E, integral with which is outer cam 15F of the second speed converter. Carrier 16F is grounded. Inner cam 14F is the output of speed converter 13F, and drives shaft 52, which may lead to further stages of speed conversion, or directly to the rotor of the generator (not shown).

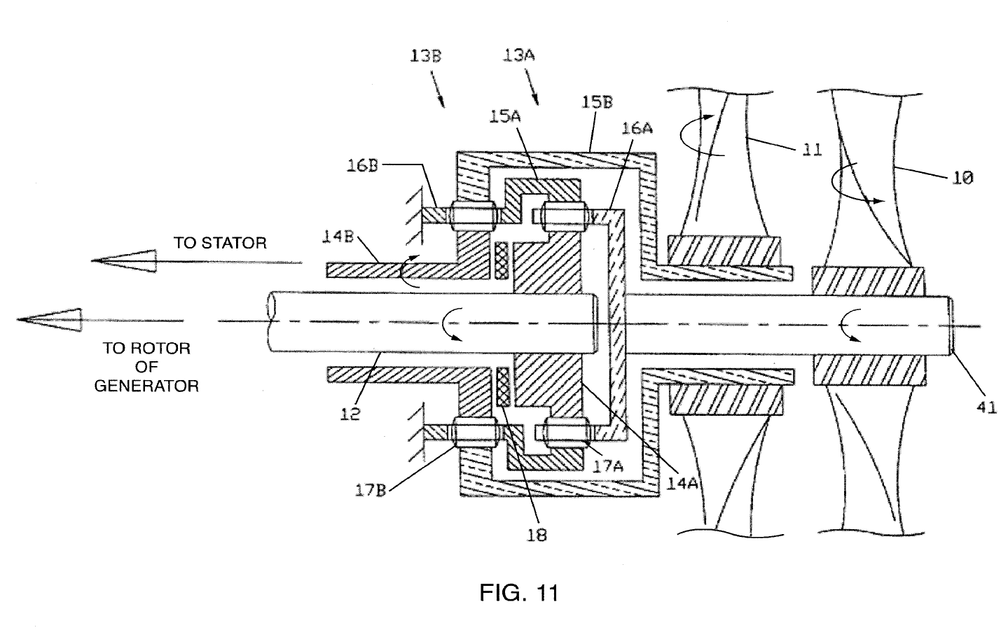

Still a further alternative embodiment of the invention in which windward rotor 10 and leeward rotor 11 counter-rotate in response to the wind is shown in FIG. 11. Rotor 10 is mounted on stub shaft 41, which drives carrier 16A of a first speed converter 13A. Rotor 11 drives outer cam 15B of a second speed converter 13B. Inner cam 14A, by way of shaft 12, drives the rotor of the generator (not shown), and inner cam 14B drives the stator of the generator (not shown). Speed converters 13A and 13B are designed such that each operates in a direction-preserving manner, that is, the blades or rotors 10 and11 (inputs) rotate in counter-rotational directions and the outputs of the speed converters 13A and 13B maintain that same counter-rotational directions, in the configuration shown. As a result, inner cams 14A and 14B also counter-rotate with respect to each other, such that the relative speed between the rotor and stator of the generator is greater than what it would be if only the rotor were driven. Included in speed converter 13A is an outer cam 15A that is grounded. Likewise, included in speed converter 13B is a carrier 16B that is grounded. Because they are both grounded, outer cam 15A and carrier 16B may be formed on the same physical part in practice.

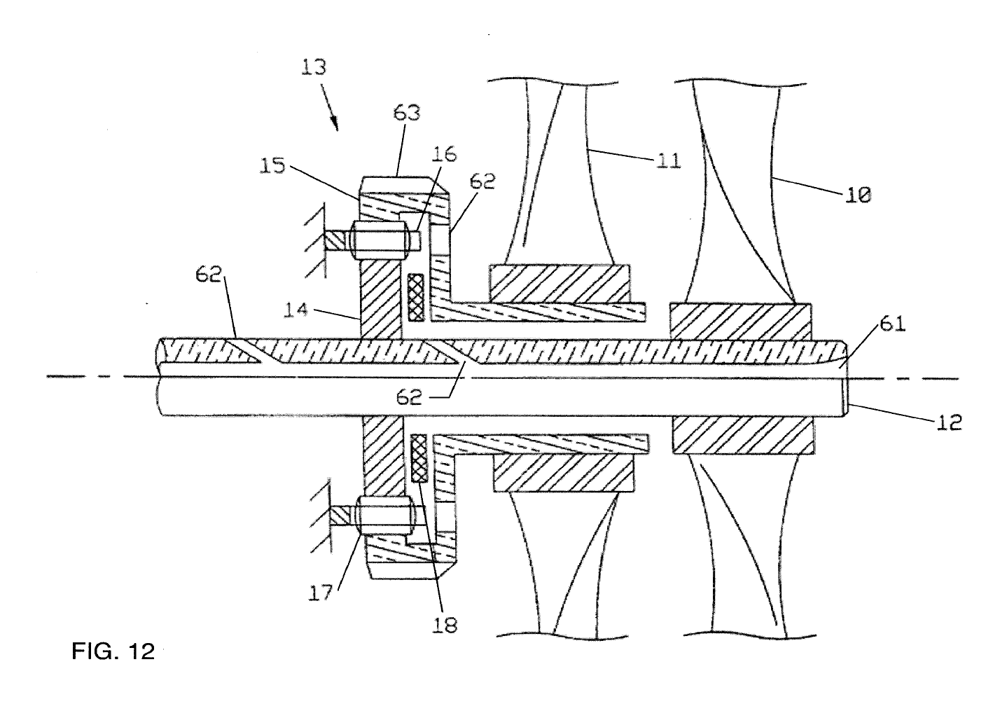

FIG. 12 shows the same basic embodiment of the invention as FIG. 1, but with certain air-cooling features added. Shaft 12 is furnished with a through-hole 61, allowing airflow into the drive. Various air channels 62 are shown as being directed towards parts of the drive where heat may be generated. In addition, the rotating outer cam 15 of speed converter 13 can be furnished with cooling fins 63, preferably helical in design so as to maximize convective heat transfer during the rotation of rotor 11.

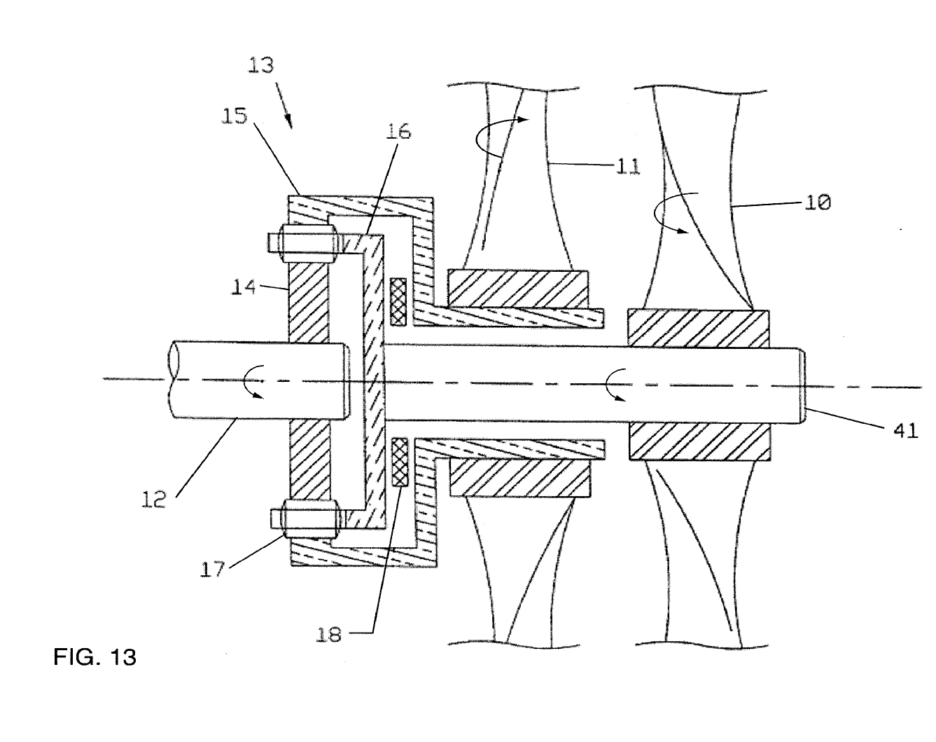

Depicted in FIG. 13 is another embodiment of the invention. Here, windward rotor 10 and leeward rotor 11, which counter-rotate in response to the moving fluid, separately drive two members of a speed converter 13 such as those shown in FIG. 2 or FIG. 5. Rotor 10 is mounted on stub shaft 41, which drives carrier 16. Rotor 11 drives outer cam 15. Inner cam 14 mounted on shaft 12 constitutes the output of the speed converter. Due to the nominally direction-reversing nature of speed converter 13, such a drive configuration results in a higher output speed than if only the carrier or only the outer cam were driven. On the other hand, the aerodynamic torques acting on the two rotors 10 and 11 will ultimately determine the relative speeds of the rotors, because this configuration does not dictate a fixed relative speed between them.

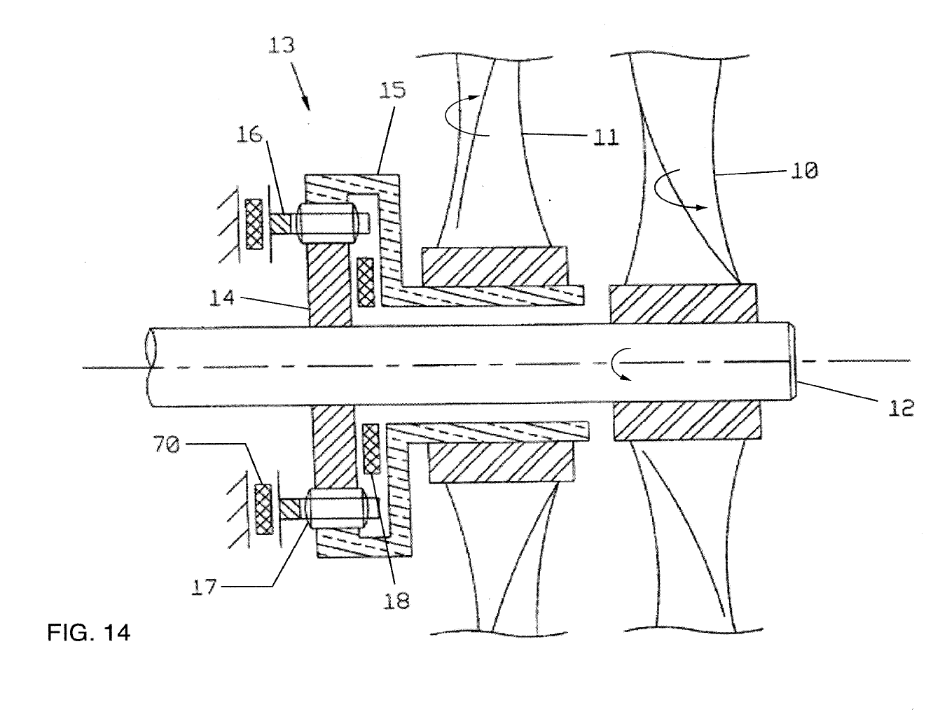

FIG. 14 shows an alternative embodiment of the same basic configuration of the drive as in FIG. 1. In addition to the components described in that context, this embodiment further includes a second clutch-brake 70, which may be used to let ground “slip” so as to adjust the relative speed of the two rotors 10 and 11 in response to changing load conditions.

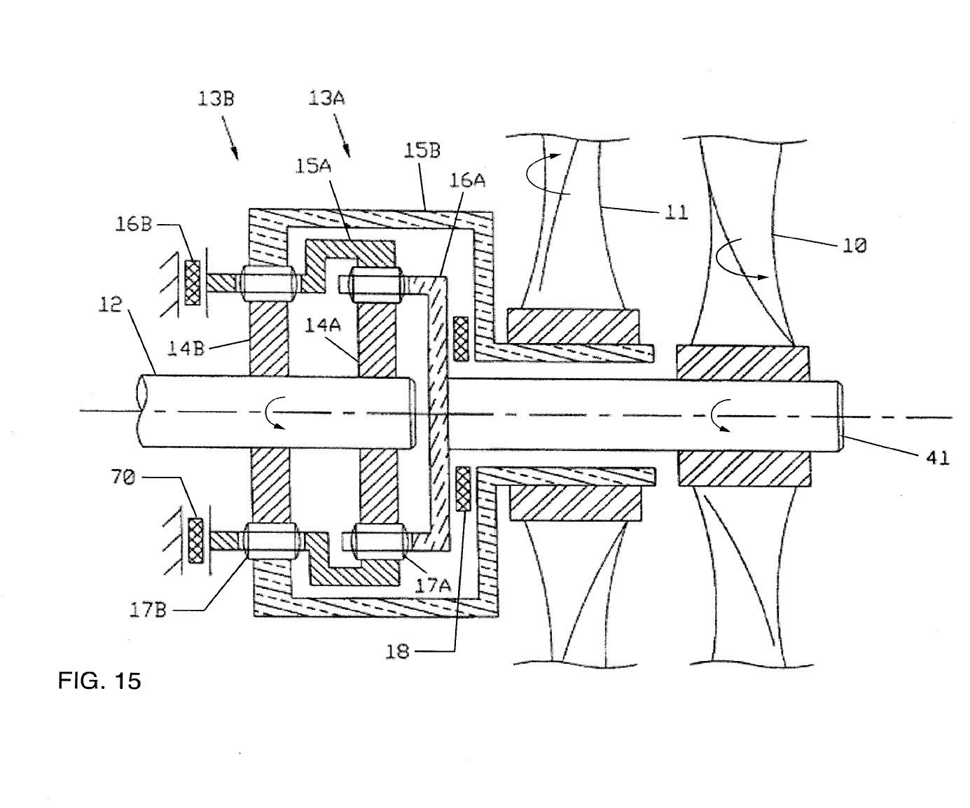

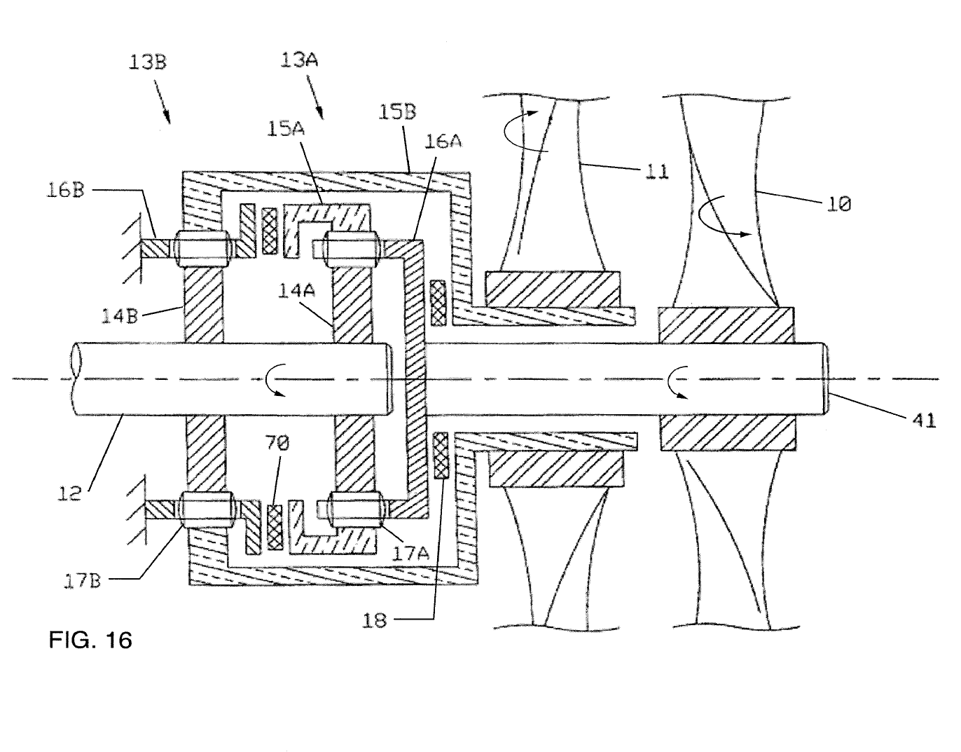

FIG. 15 depicts an alternative embodiment of the same basic configuration of the drive as in FIG. 7. In addition to the components described in that context, this embodiment further includes a second clutch-brake 70. By way of this clutch-brake, one may let ground “slip” so as to adjust the generator speed in response to changing load conditions. The relative speed of the two rotors 10 and 11 is unaffected, however. In contrast, in the alternative embodiment shown in FIG. 16, the second clutch-brake 70 is interposed between outer cam 15A of the first speed converter 13A and (grounded) carrier 16B of the second speed converter 13B. Clutch-brake 70 may be used to let ground “slip” in the first speed converter 13A so as to adjust the relative speed of the two rotors 10 and 11 in response to changing load conditions.

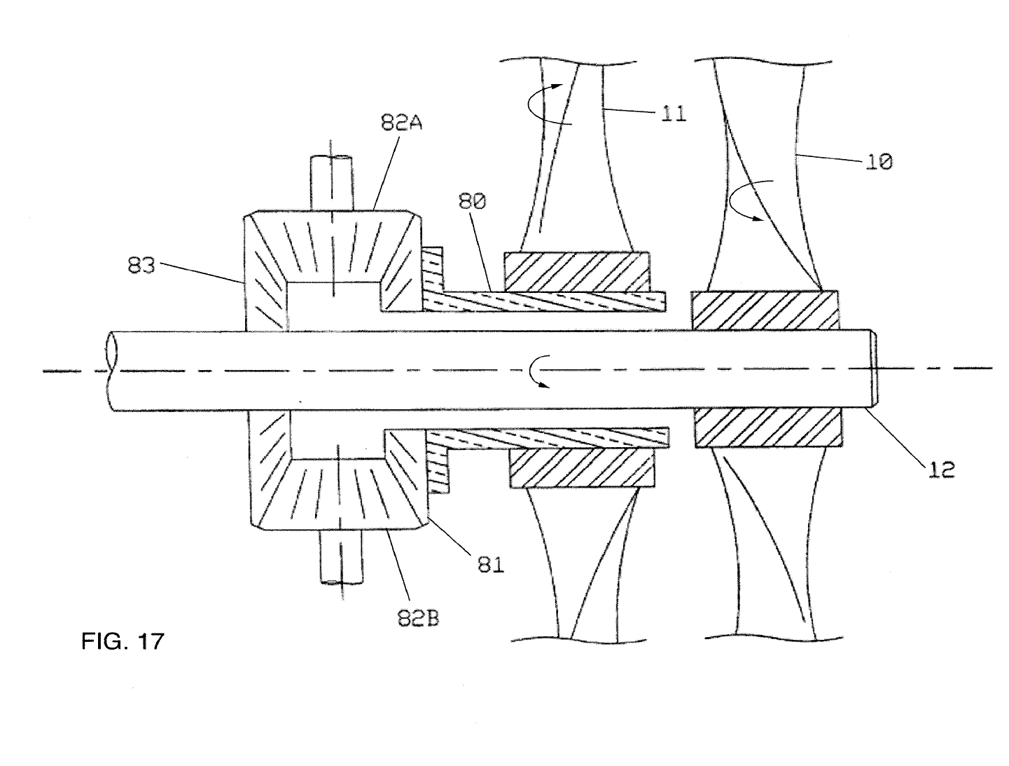

Shown in FIG. 17 is a bevel-gear counterpart of the same basic configuration of the drive as in FIG. 1. Rotor 10 is mounted directly on shaft 12, which leads, either directly, or through further speed conversion stages (not shown), to the generator. Rotor 11 drives the same shaft 12 through a bevel gear train by way of hollow shaft 80. The bevel gear train includes a bevel gear 83 that is mounted on shaft 12 and constitutes the output. Hollow shaft 80 is connected to a similar, but open-centered bevel gear 81 on the opposite side, while pinions 82A and 82B, both spindled on ground, are interposed between bevel gears 81 and 83. Such a configuration would be best suited to a 1:1 speed ratio (in opposite directions) between rotors 10 and 11.

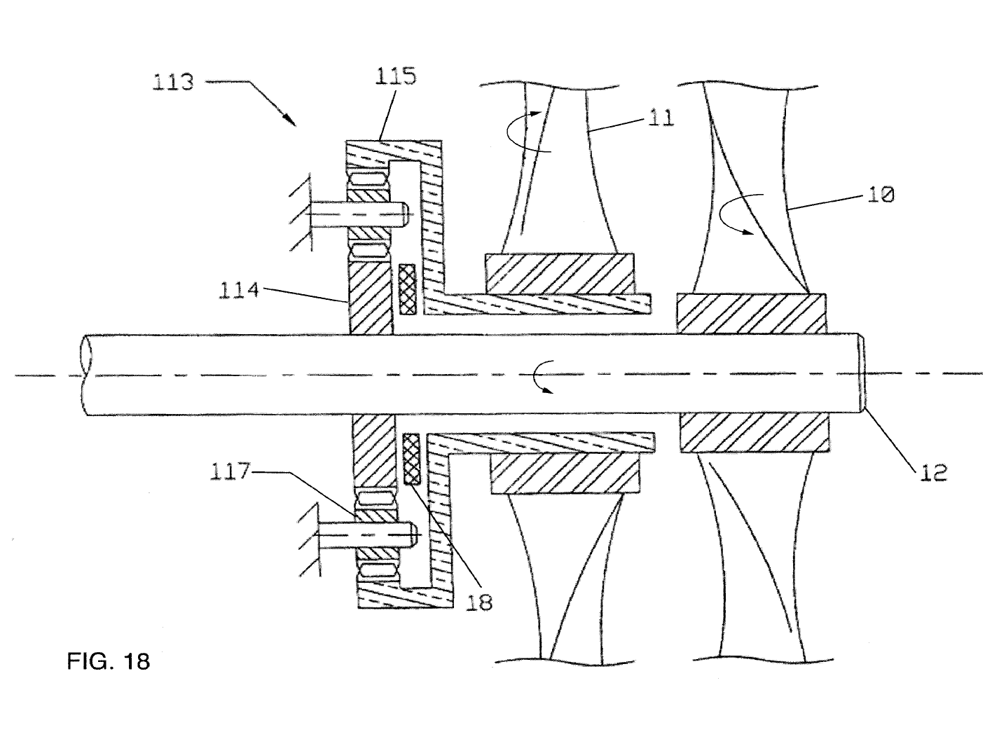

Similarly, FIG. 18 shows a planetary gear counterpart of the same basic configuration of the drive as in FIG. 1. Rotor 10 is mounted directly on shaft 12, which leads, either directly, or through further speed conversion stages (not shown), to the generator. Rotor 11 drives the same shaft 12 through a planetary gearset 113. Planetary gearset 113 includes sun gear 114, which is mounted on shaft 12 and constitutes the output. A multiplicity of planets 117 are spindled on ground and interposed between sun gear 114 and ring gear 115, which is driven by rotor 11 in the opposite direction from rotor 10. Due to the character of a planetary gearset, this arrangement is limited to speed ratios other than 1:1 (in opposite directions) between rotors 10 and 11. In contrast, with cam and roller type speed converters described earlier and depicted in FIGS. 2 through 5, the speed ratio between the two rotors may be equal to or different from 1:1, without limitations.

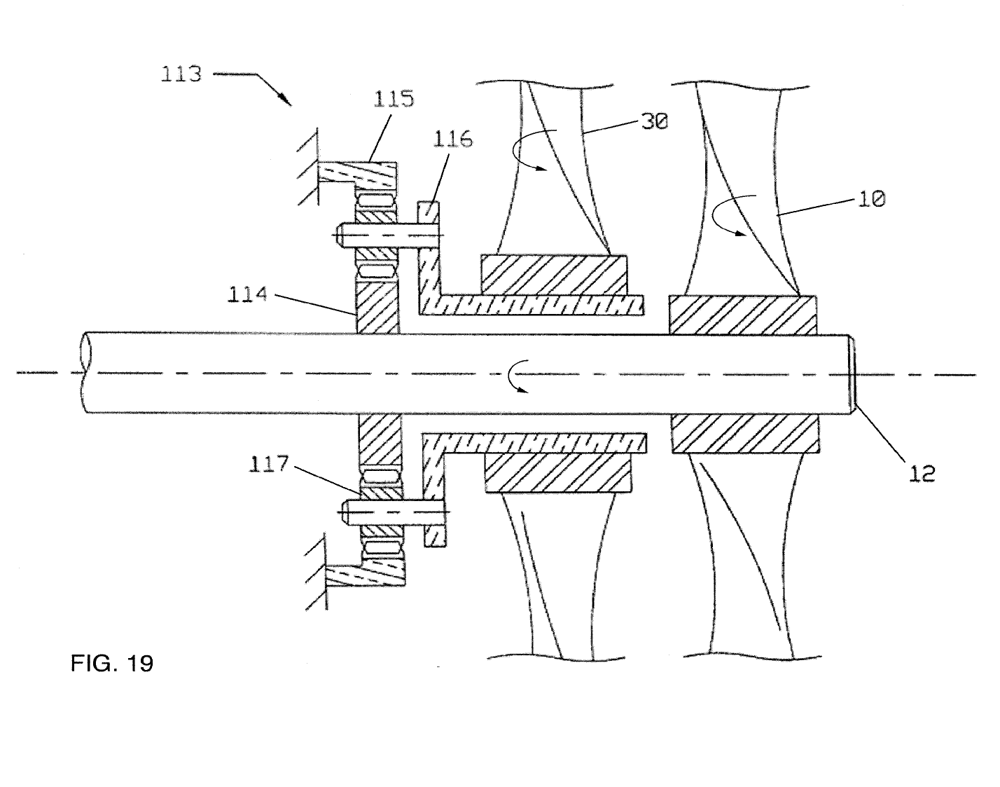

Shown in FIG. 19 is a planetary gear counterpart of the same basic configuration of the drive as in FIG. 6. Rotor 10 is mounted directly on shaft 12, which leads, either directly, or through further speed conversion stages (not shown), to the generator. Rotor 30 drives the same shaft 12 through a planetary gearset 113. Planetary gearset 113 includes sun gear 114, which is mounted on shaft 12 and constitutes the output. A multiplicity of planets 117 are spindled on carrier 116 and interposed between sun gear 114 and ring gear 115, which is grounded. Carrier 116 is driven by rotor 30 in the same direction as rotor 10.

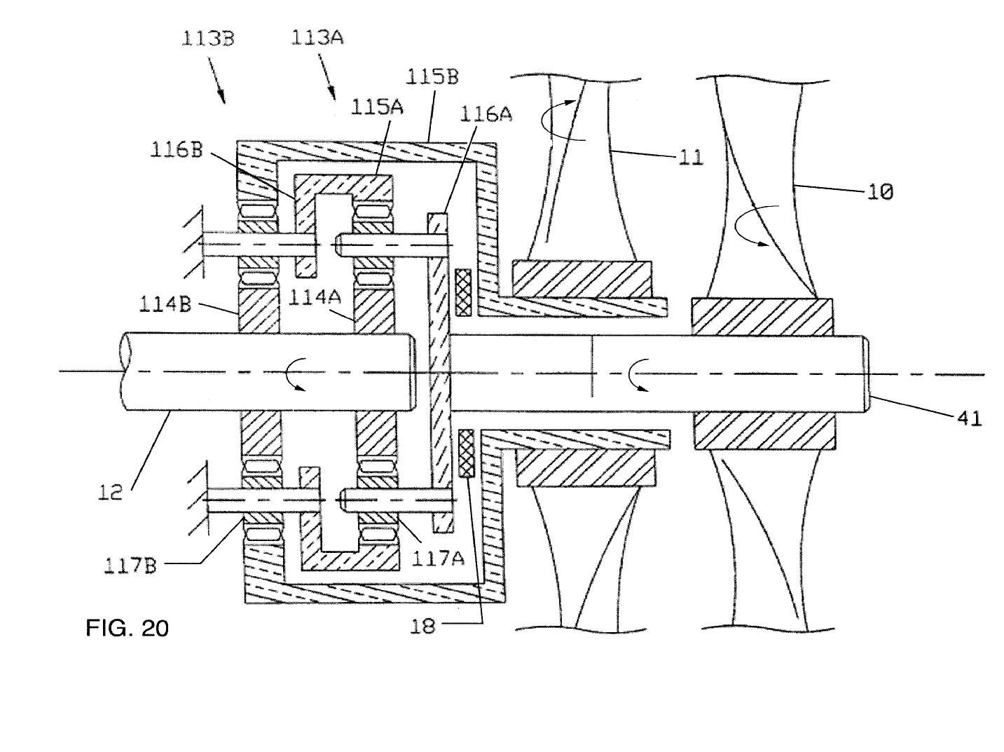

FIG. 20 shows a planetary gear counterpart of the same basic configuration of the drive as in FIG. 7. Rotor 10 is mounted on stub shaft 41, which drives carrier 116A of a first planetary gearset 113A. Rotor 11 drives ring gear 115B of a second planetary gearset 113B. Sun gears 114A and 114B of both planetary gearsets are mounted on shaft 12 and constitute the output of the gearsets. Also included in gearset 113A is a ring gear 115A that is grounded. Likewise, included in gearset 113B is a carrier 116B that is grounded. Because they are both grounded, ring gear 115A and carrier 116B may be formed on the same physical part in practice. Spindled on carriers 116A and 116B are respective planet gears 117A and 117B.

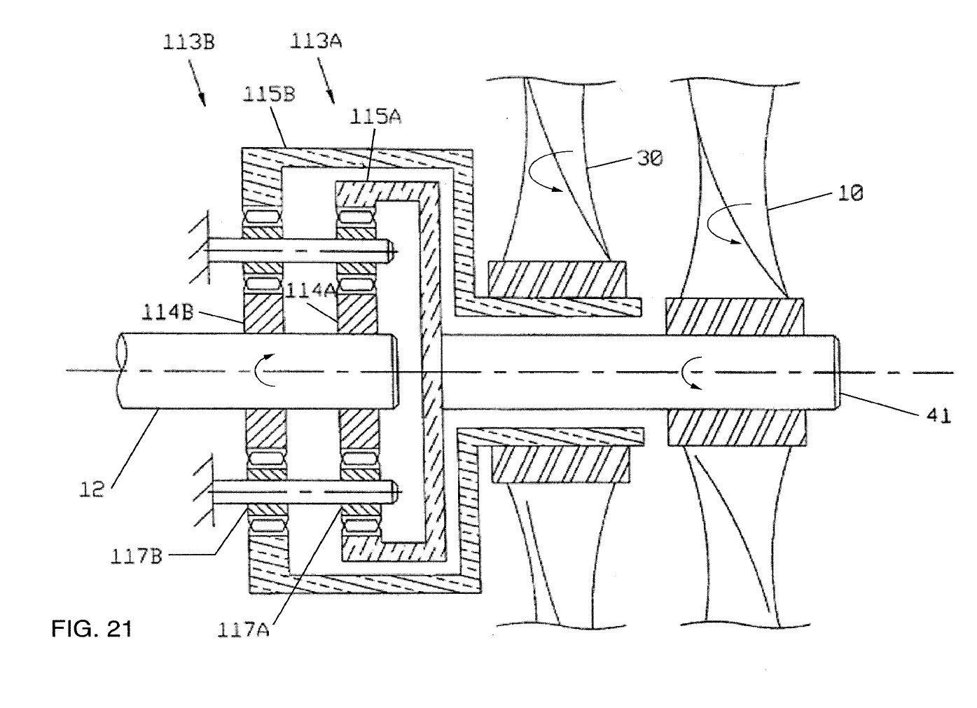

Likewise, shown in FIG. 21 is a planetary gear counterpart of the same basic configuration of the drive as in FIG. 8. Rotor 10 is mounted on stub shaft 41, which drives ring gear 115A of a first planetary gearset 113A. Rotor 30 drives ring gear 115B of a second planetary gearset 113B. Sun gears 114A and 114B of both planetary gearsets are mounted on shaft 12 and constitute the output of the gearsets. Planet gears 117A and 117B of the respective gearsets are spindled on ground.

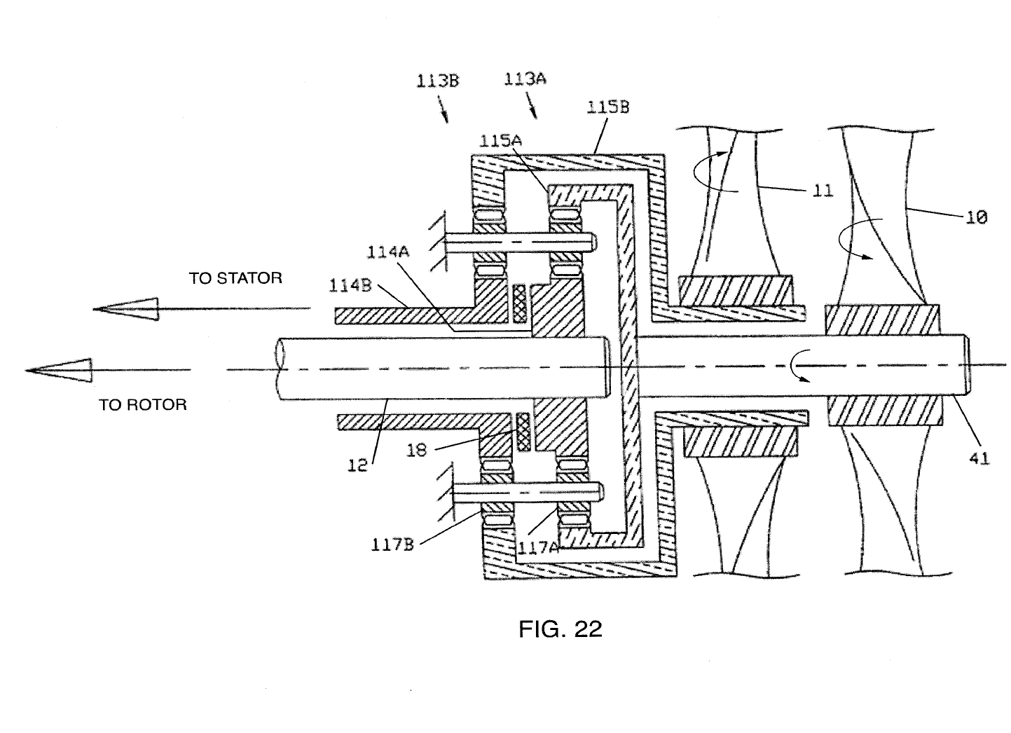

FIG. 22 illustrates a planetary gear counterpart of the same basic configuration of the drive as in FIG. 11. Rotor 10 is mounted on stub shaft 41, which drives ring gear 115A of a first planetary gearset 113A. Rotor 11 drives ring gear 115B of a second planetary gearset 113B. Sun gear 114A, by way of shaft 12, drives the rotor of the generator (not shown), and sun gear 114B drives the stator of the generator (not shown). Sun gears 114A and 114B counter-rotate with respect to each other, such that the relative speed between the rotor and stator of the generator is greater than what it would be if only the rotor were driven. Included in planetary gearsets 113A and 113B are respective planet gears 117A and 117B that are spindled on ground.

Although the invention has been described with respect to various embodiments, it should be realized this invention is also capable of a wide variety of further and other embodiments within the spirit and scope of the claimed invention.

What is claimed is:

1. A device for changing fluid flow through a pair of blades from a first type of energy to a second type of energy:
a first blade connected to a single shaft to receive said fluid flow and rotate said first blade in a first direction;
a second blade connected to said single shaft to receive said fluid and rotate said second blade in a second direction; and
said second blade connected to said single shaft by an inner cam that is mounted to said single shaft, an outer cam, a reaction carrier that is grounded and at least one rolling element;
said single shaft connected to a generator for transferring said fluid flow into electrical energy;
wherein said single shaft rotates in a single direction.

2. A device as defined in claim 1, further comprising at least one clutch-brake which when engaged the two blades are braked against each other to be slowed down and stopped with minimum reaction torque.

3. A device as defined in claim 1, further comprising 1:1 speed ratio between said inner cam and said outer cam.

4. A device as defined in claim 1, wherein said fluid flow is wind.

5. A device as defined in claim 1, wherein said fluid flow is water.

6. A device as defined in claim 2, further comprising at least another clutch-brake which when engaged to let the ground slip so as to adjust the relative speed of the two blades in response to changing load conditions.

7. A device as defined in claim 1, further comprising:
said single shaft has a longitudinal hole there through and a series of fluid channels may be incorporated therein.

8. A device as defined in claim 7 wherein there is at least one fin incorporated in said outer cam.

9. A device for changing fluid flow through a pair of blades from a first type of energy to a second type of energy:
a first blade connected to a single shaft to receive said fluid flow and rotate said first blade in a first direction;
a second blade connected to said single shaft to receive said fluid and rotate said second blade in said first direction; and
said second blade connected to said single shaft by an inner cam that is mounted to said single shaft, an outer cam that is grounded, a reaction carrier and at least one rolling element;
said single shaft connected to a generator for transferring said fluid flow into electrical energy;
wherein said single shaft rotates in a single direction.

10. A device as defined in claim 9, further comprising 1:1 speed ratio between said inner cam and said outer cam.

11. A device as defined in claim 9, wherein said fluid flow is wind.

12. A device as defined in claim 9, wherein said fluid flow is water.

13. A device as defined in claim 9, further comprising:
said single shaft has a longitudinal hole there through and a series of fluid channels may be incorporated therein.

14. A device as defined in claim 13, wherein there is at least one fin incorporated in said out cam.

15. A device for changing fluid flow through a pair of blades from a first type of energy to a second type of energy:
a first blade connected to a first shaft to receive said fluid flow and rotate said first blade in a first direction;
said first shaft connected to a second shaft by a first inner cam that is mounted to said second shaft, a first outer cam, a first reaction carrier that is mounted to the first shaft and at least one rolling element;
a second blade connected to said second shaft and to receive said fluid and rotate said second blade in a second direction; and
said second blade connected to said second shaft by an inner cam that is mounted to said second shaft, an outer cam, a reaction carrier that is grounded and at least one rolling element;
said second shaft connected to a generator for transferring said fluid flow into electrical energy;
wherein said second shaft rotates in the same direction as the first direction.

16. A device as defined in claim 15, further comprising at least one clutch-brake which when engaged the two blades are braked against each other to be slowed down and stopped with minimum reaction torque.

17. A device as defined in claim 15, further comprising 1:1 speed ratio between said inner cam and said outer cam.

18. A device as defined in claim 15, wherein said fluid flow is wind.

19. A device as defined in claim 15, wherein said fluid flow is water.

20. A device as defined in claim 16, further comprising at least another clutch-brake which when engaged to let the ground slip so as to adjust the relative speed of the two blades in response to changing load conditions.

21. A device as defined in claim 15, further comprising:
said single shaft has a longitudinal hole there through and a series of fluid channels may be incorporated therein.

22. A device for changing fluid flow through a pair of blades from a first type of energy to a second type of energy:
a first blade connected to a first shaft to receive said fluid flow and rotate said first blade in a first direction;
said first shaft connected to a second shaft by a first inner cam that is mounted to said second shaft, a first outer cam that is mounted to the first shaft, a first reaction carrier and at least one rolling element;
a second blade connected to said second shaft and to receive said fluid and rotate said second blade in the first direction;
said second blade connected to said second shaft by an inner cam that is mounted to said second shaft, an outer cam that is connected to the second blade, a reaction carrier that is grounded and at least one rolling element;
said second shaft connected to a generator for transferring said fluid flow into electrical energy; and
wherein said second shaft rotates in the opposite direction of the first direction.

23. A device for changing fluid flow through a pair of blades from a first type of energy to a second type of energy:
a first blade connected to a first shaft to receive said fluid flow and rotate said first blade in a first direction;
a second shaft having an inner cam that is mounted to said second shaft, an outer cam grounded, a reaction carrier that is attached to said first shaft and at least one roller element;
said second shaft having a reaction carrier, a third shaft having an inner cam that is mounted to said third shaft, said outer cam grounded, a reaction carrier that is attached to said second shaft and at least one roller element;
said third shaft connected to a generator for transferring said fluid flow into electrical energy; and
wherein said second shaft and said third shaft rotates in the same direction as the first direction.

24. A device for changing fluid flow through a pair of blades from a first type of energy to a second type of energy:
a first blade connected to a first shaft to receive said fluid flow and rotate said first blade in a first direction;
a second blade connected to a first shaft to receive said fluid flow and rotate said second in a first direction;
an intermediate element having an inner cam, a reaction carrier that is attached to said first shaft and at least one roller element,
a second shaft having an inner cam that is mounted to said second shaft, an outer cam formed on said intermediate element, a reaction carrier that is grounded and at least one roller element;
said second shaft is connected to a generator for transferring said fluid flow into electrical energy; and
wherein said second shaft rotates in the opposite direction of the first direction.

25. A device for changing fluid flow through a pair of blades from a first type of energy to a second type of energy:
a first blade connected to a first shaft to receive said fluid flow and rotate said first blade in a first direction;
said first shaft connected to a second shaft by a first inner cam that is mounted to said second shaft, a first outer cam grounded, a first reaction carrier that is mounted to the first shaft and at least one rolling element, said second shaft connected to the rotor of a generator;
a second blade connected to a stator of said generator and to receive said fluid and rotate said second blade in a second direction; and
said second blade connected to said stator by an inner cam that is mounted to said stator, an outer cam, a reaction carrier that is grounded and at least one rolling element;
wherein said second shaft rotates opposite said stator.

26. A device as defined in claim 25, further comprising at least one clutch-brake which when engaged the stator and the inner cam are braked against each other to be slowed down and stopped with minimum reaction torque.

27. A device for changing fluid flow through a pair of blades from a first type of energy to a second type of energy:
a first blade connected to a first shaft to receive said fluid flow and rotate said first blade in a first direction;
said first shaft connected to a second shaft by a first inner cam that is mounted to said second shaft, a first outer cam, a first reaction carrier that is mounted to the first shaft and at least one rolling element;
a second blade connected to said second shaft and to receive said fluid and rotate said second blade in a second direction; and
said second blade connected to said second shaft by an outer cam that is mounted to said second shaft;
said second shaft connected to a generator for transferring said fluid flow into electrical energy;
wherein said second shaft rotates in the same direction as the first direction.

28. A device as defined in claim 27, further comprising at least one clutch-brake which when engaged the two blades are braked against each other to be slowed down and stopped with minimum reaction torque.

29. A device for changing fluid flow through a pair of blades from a first type of energy to a second type of energy:
a first blade connected to a single shaft to receive said fluid flow and rotate said first blade in a first direction;
a second blade connected to said single shaft to receive said fluid and rotate said second blade in a second direction; and
said second blade connected to said single shaft by a bevel-gear train;
said single shaft connected to a generator for transferring said fluid flow into electrical energy;
wherein said single shaft rotates in a single direction.

30. A device for changing fluid flow through a pair of blades from a first type of energy to a second type of energy:
a first blade connected to a single shaft to receive said fluid flow and rotate said first blade in a first direction;
a second blade connected to said single shaft to receive said fluid and rotate said second blade in a second direction; and
said second blade connected to said single shaft by a planetary gear train;
said single shaft connected to a generator for transferring said fluid flow into electrical energy;
wherein said single shaft rotates in a single direction.

31. A device for changing fluid flow through a pair of blades from a first type of energy to a second type of energy:
a first blade connected to a single shaft to receive said fluid flow and rotate said first blade in a first direction;
a second blade connected to said single shaft to receive said fluid and rotate said second blade in said first direction; and
said second blade connected to said single shaft by a planetary gear train;
said single shaft connected to a generator for transferring said fluid flow into electrical energy;
wherein said single shaft rotates in a single direction.

32. A device for changing fluid flow through a pair of blades from a first type of energy to a second type of energy:
a first blade connected to a first shaft to receive said fluid flow and rotate said first blade in a first direction;
said first shaft connected to a second shaft by a planetary gear train;
a second blade connected to said second shaft and to receive said fluid and rotate said second blade in a second direction; and
said second blade connected to said second shaft by a planetary gear train;
said second shaft connected to a generator for transferring said fluid flow into electrical energy;
wherein said second shaft rotates in the same direction as said first direction.

33. A device for changing fluid flow through a pair of blades from a first type of energy to a second type of energy:
a first blade connected to a first shaft to receive said fluid flow and rotate said first blade in a first direction;
said first shaft attached to said second shaft by a planetary gear train;
a second blade connected to said second shaft and to receive said fluid and rotate said second blade in the first direction;
said second blade connected to said second shaft by a planetary gear train;
said second shaft connected to a generator for transferring said fluid flow into electrical energy; and
wherein said second shaft rotates in the opposite direction as said first direction.
